(19) United States
(12) Patent Application Publication
(10) Pub. No.: US 2012/0198755 A1
(43) Pub. Date: Aug. 9, 2012

(54) Sub-Surface Insect Bait Station

(76) Inventor: Donald E. Soards, Rio Rancho, NM (US)

(21) Appl. No.: 12/906,929

(22) Filed: Oct. 18, 2010

(51) Int. Cl. A01M 1/20; A01M 1/00

(52) U.S. Cl. 43/131; 43/132.1

(57) ABSTRACT

A sub-surface bait station for attracting insect pests for treatment with pesticides having a housing with vertical sides and a lid removably fitted to the housing with apertures to facilitate the passage of insect pests through the lid and into the housing. Various insect lures and baits may be placed in the housing. Coarse aggregate covers the bait station sized to allow insect pests to travel through the aggregate and pass into the bait station.

### BACKGROUND OF THE INVENTION

The present invention relates to an insect lure or bait station for attracting common household insect pests for treatment with a pesticide and, more particularly, to such a bait station located below ground level and outside a residence or other structure.

### SUMMARY OF THE INVENTION

Undesirable crawling insect pests, such as ants, cockroaches, spiders, and the like, find their way into residences and other buildings and cause owners to employ pesticides in an ongoing battle to destroy the invaders. Such pesticides are commonly sprayed by professionals or owners along interior and exterior perimeters of structures and in other interior locations. Pesticide foggers are often employed, filling the structure with a thick fog of pesticide gas. Commercially available products, such as cockroach and ant baits and traps, are also deployed inside structures, usually in out-of-the-way locations, hopefully free from interference by young children and pets.

Such pesticides are potent chemicals and present a potential health hazard for humans, pets, and the environment. Persons with a particular sensitively to one or more chemical components found in such pesticides often find that they are unable to use such products at all and are forced to live with the invading pests.

It is a primary object of the present invention to provide a bait station for crawling insect pests which effectively controls such pests while doing so without the health risks associated with conventional means for pest control.

Another object of the present invention is to provide a bait station which is inexpensive to construct or purchase.

It is a further object of the present invention to provide a bait station which is easy to operate and maintain.

Yet another object of the present invention is to provide a bait station which can safely and inconspicuously be deployed at various locations around a residence or other building.

Other objects, features, and characteristics of the present invention, as well as the methods of operation, and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 is a perspective view of a bait station in accordance with the present invention;

FIG. 2 is a perspective view of an alternative bait station in accordance with the present invention.

FIG. 3 is an elevational cut-away view of an installed bait station in accordance with the present invention;

FIG. 4 is a plan sectional view of a typical residence and yard, further illustrating locations where bait stations in accordance with the present invention may be deployed.

### DETAILED DESCRIPTION OF THE PRESENTLY PREFERRED EMBODIMENT

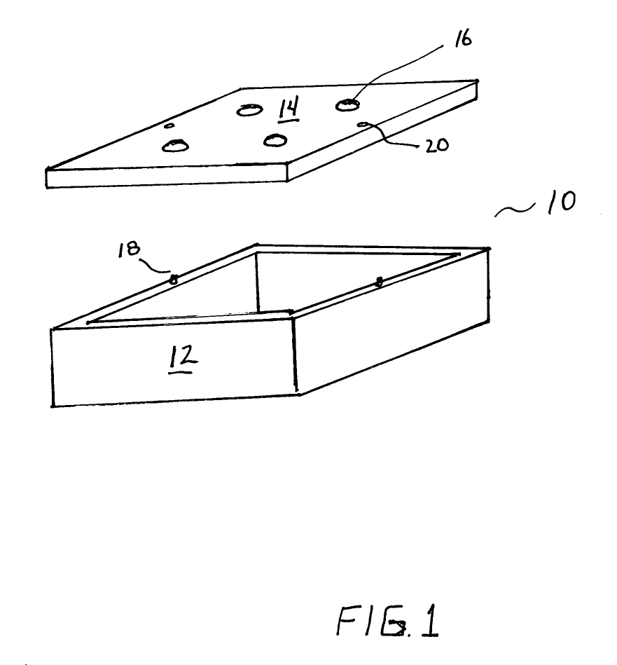

A bait station 10 in accordance with the present invention can be seen by referring to FIG. 1. It consists of a housing 12 and lid 14. As shown, the housing does not have a base so as to facilitate drainage. Alternatively, a solid base may be used, or a base with openings to allow drainage.

In a preferred embodiment, the housing 12 is a box section that is site-built, preferably of redwood or pressure-treated lumber. Readily available 2×4's or 2×6's may be used. The lid 14 should also be fashioned from weather-resistant wood or plywood and sized to completely cover the box section. If desired, the base may also be fashioned from weather-resistant wood or plywood. It is desirable that the lid be sufficiently thick so as to prevent the bait station from collapse if stepped on. It further is desirable that means be employed to lock the lid in place over the box section. Again referring to FIG. 1, two dowels 18 are shown which mate with dowel receiving holes 20 to secure the lid to the box section.

The lid 14 is illustrated with a set of holes 16 which provide insect access to the box section 12. Such holes should be in the range of one-half inch to one inch in diameter. Four holes are illustrated, as this number has proven adequate. However, additional holes may be employed.

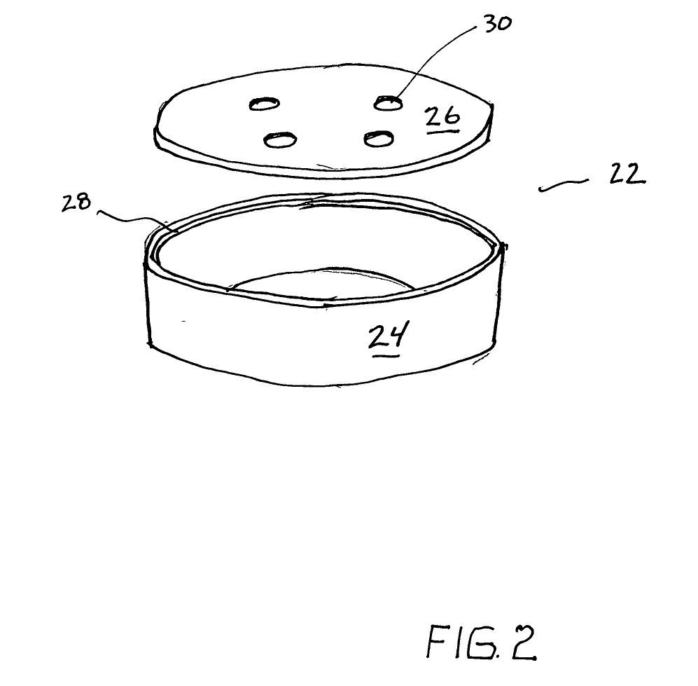

Each side of a bait station 10 should in the range of 8 inches to 16 inches long. Bait stations may also be constructed out of galvanized steel, aluminum, or weather-resistant plastics. If desired, the overall shape of a bait station in accordance with the present invention may be square, rectangular, triangular, oblong, or round. If a bait station is to be pre-manufactured, a particularly desirable design for such a bait station may be seen by reference to FIG. 2. The alternative bait station 22 is constructed from weather-resistant plastic. It has a generally round housing 24 and a round lid 26 which is received in a recessed lip 28 formed into the rim of the housing. The lid is constructed of reinforced rigid plastic and is capable of bearing the weight of an adult. The lid 26 is illustrated having a set of access holes 30 which provide insect access to the housing 24. Such holes should be in the range of one-half inch to one inch in diameter. Four holes are illustrated and preferred, but additional holes may be employed. The alternative bait station 20 should be approximately 10 inches to 16 inches in diameter with sides that are approximately 3 inches to 4 inches high.

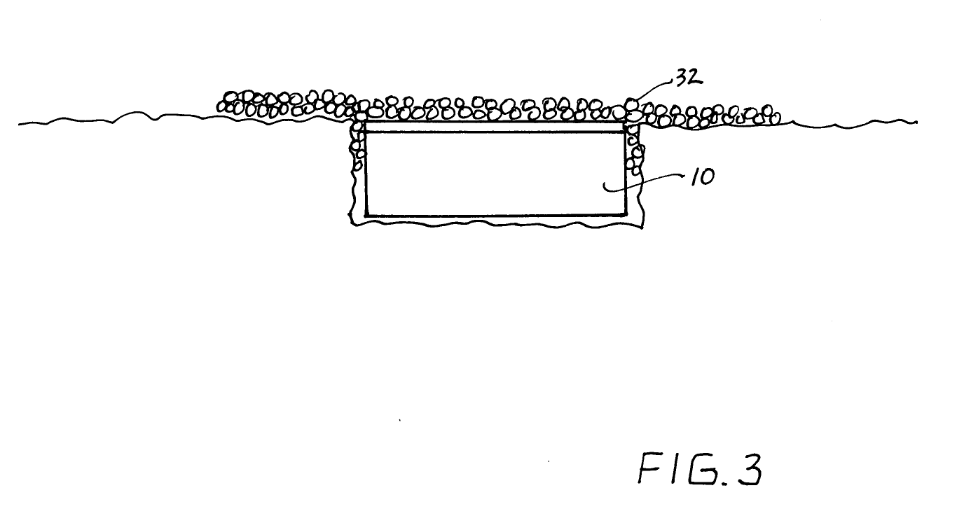

Referring now to FIG. 3, a bait station 10 can be seen as installed in an outside location near a residence or other structure. First a hole is dug in the ground of sufficient size to accommodate the bait station and at least one inch deeper than the height of the station. If drainage is a concern, the hole may be dug deeper and drainage gravel employed under the bait station. The bait station should be situated in the hole such that the top of the station is approximately at least one inch below the natural ground line and with some space between the walls of the station and the sides of the dug hole.

Once situated, the bait station 10 should be covered and surrounded with a coarse aggregate, such as rock 32, to a depth of approximately two to four inches so as to anchor the bait station in the ground. The material selected to cover the bait station 10 needs to be sufficiently large such that when such material is positioned over and around the bait station there exist sufficient passageways for insects to navigate through the material and realize ingress to the bait station.

The coarse aggregate serves to isolate the bait station from unintended access by children, pets, and the like. It also has been observed that insect pests appear to like the cover provided by the aggregate, and such pests are more likely to visit a covered bait station than an uncovered station.

Various sizes and shapes of coarse aggregate may be utilized as a cover so long as the minimum dimension of such aggregate exceeds one inch (not passing a one-inch sieve). Gravel or crushed rock are particularly desirable, but wood or bark chips may also be utilized. It is recommended that the aggregate covering surround and extend away from the Bug Box so as to stabilize such aggregate for foot traffic.

It is recommended that several bait stations in accordance with the present invention be deployed in the vicinity of a residence or other structure to control crawling insect pests. A particularly recommended strategy is to install a bait station in the vicinity of the primary ground-level penetrations to the structure, most commonly doors. The bait station may be located in an advantageous spot, but no greater than 25 feet from the point of insect access to the structure.

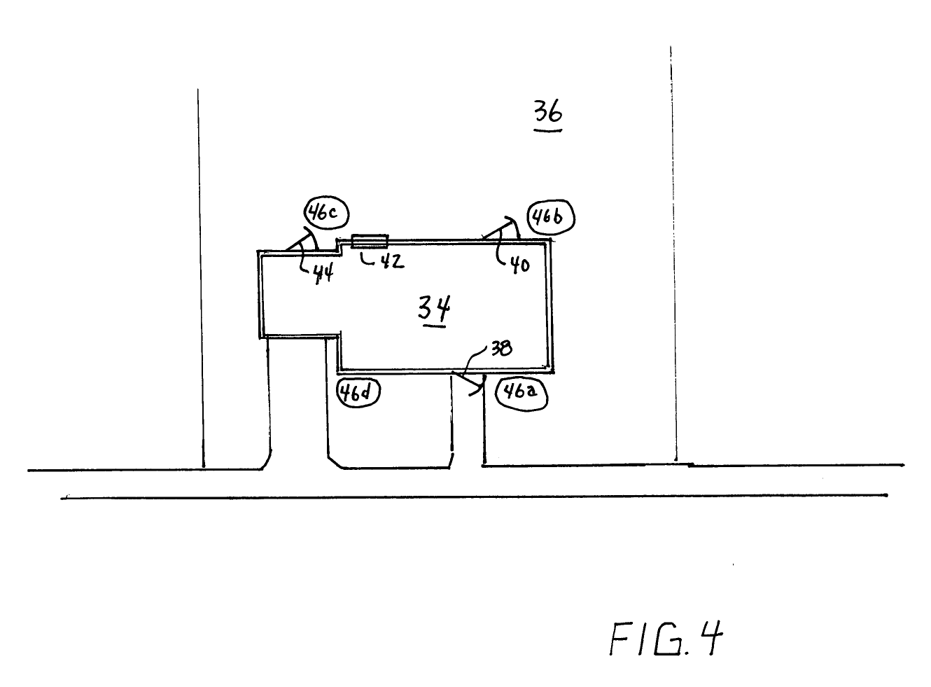

Referring now to FIG. 4, a plan sectional view of a typical residence 34 and residential lot 36 is shown. This residence has a front door 38, a rear door 40, a sliding door 42 in the master bedroom, and a rear garage door 44. Also shown are four bait stations, 46a-46d, positioned proximately to the residence doors.

The exact placement of bait stations is not critical as long as they are positioned close to insect access points. If desirable, a bait station may be located within existing landscape features, such as flower beds or other planting areas, or under existing trees or shrubs.

Once positioned, bait stations in accordance with the present invention need to periodically be filled with suitable and widely available baits and lures to control the insect pests of interest to the user. For example, if in a given locale a user is most concerned about the control of ants and cockroaches, then a combination of roach and ant baits, roach egg stoppers, and roach motels should be utilized. Such products include, but are not limited to: Raid Small Roach Baits, Raid Egg Stoppers, Combat Roach Bait Stations, Combat Ant Bait Stations, TAT Ant Bait Stations, and Roach Motels. Such baits and lures are widely available in numerous retail stores and are approved for residential use. Since these baits and lures are approved for use within the home, there is very little potential for harm to children or pets who might get into the bait station.

To maintain a bait station in accordance with the present invention, a user scrapes back the gravel or bark from the bait station lid, opens the lid, removes the used bait and lures and accumulated dead insects, installs new bait and lures, replaces the lid, and scrapes the gravel back over the lid of the bait station. Such a procedure should be done two to four times per year, or more often as experience dictates.

Bait stations generally in accordance with the present invention may be employed to attract and destroy insect pests other than the crawling insect pests which are the bane of residential and commercial structures. Bait stations may be employed with suitable insecticides and pesticides to protect ornamental and fruit trees from beetle and grub infestations and agricultural crops from various infestations. In such applications, the size of bait stations may need to be modified to be suitable for use against the targeted pests.

Those skilled in the art will realize that numerous modifications to the apparatus and methods described herein may be made, and that such modifications do not depart from the spirit of the invention. It is therefore intended that the invention not be limited to the specific embodiments disclosed, but it is to be limited only by the claims appended hereto.

What is claimed is:

1. An insect bait station for attracting insect pests adapted to be installed in the ground below ground level, said station comprising:
a housing having substantially vertical walls;
a lid having a plurality of apertures suitable for ingress by insect pests, said lid removably connected to said housing;
material capable of killing insect pests deployed within said housing; and
coarse aggregate covering said station.

2. The station of claim 1, further comprising a base attached to said housing.

3. The station of claim 2, wherein said base is solid.

4. The station of claim 2, wherein said base has a multitude of apertures.

5. The station of claim 1, wherein said station is situated three to four inches below ground level.

6. The station of claim 2, wherein said station is situated three to four inches below ground level.

7. The station of claim 1, wherein said lid has in the range of three to five apertures, each of said apertures with an opening of no less than one-half inch.

8. The station of claim 2, wherein said lid has in the range of three to five apertures, each of said apertures with an opening of no less than one-half inch.

9. The station of claim 1, wherein said aggregate has a minimum dimension exceeding one inch.

10. The station of claim 2, wherein said aggregate has a minimum dimension exceeding one inch.

11. The station of claim 9, wherein said aggregate is selected from the group of gravel, crushed rock, bark chips, and wood chips.

12. The station of claim 10, wherein said aggregate is selected from the group of gravel, crushed rock, bark chips, and wood chips.

13. The station of claim 1, wherein said aggregate is selected so as to permit the subterranean ingress of insect pests through said aggregate from the surface of the ground to said station.

14. The station of claim 2, wherein said aggregate is selected so as to permit the subterranean ingress of insect pests through said aggregate from the surface of the ground to said station.

15. The station of claim 1, wherein said station is site-built of wood.

16. The station of claim 2, wherein said station is site-built of wood.

17. The station of claim 1, wherein said station is constructed of weather-resistant plastic.

18. The station of claim 2, wherein said station is constructed of weather-resistant plastic.

19. The station of claim 17, wherein said lid is received in a recessed lip formed into the rim of said housing.

20. The station of claim 18, wherein said lid is received in a recessed lip formed into the rim of said housing.
